(19) United States
(12) Patent Application Publication
(10) Pub. No.: US 2006/0176934 A1
(43) Pub. Date: Aug. 10, 2006

(54) Serial transmission of data using spread-spectrum modulation for enhancing electromagnetic compatibility

(75) Inventors: Michael Riedel, Buchbach (DE); Roland Neumann, Bad Tolz (DE)

Correspondence Address: Silicon Edge Law Group LLP, Suite 245, 6601 Koll Center Parkway, Pleasanton, CA, 94566, US

(73) Assignee: INOVA Semiconductors GmbH

(21) Appl. No.: 11/341,346

(22) Filed: Jan. 26, 2006

Related U.S. Application Data
(63) Continuation of application No. PCT/EP05/25063, filed on Feb. 7, 2005.

(30) Foreign Application Priority Data
Feb. 7, 2005 (DE) 20 2005 001 929.1
Feb. 7, 2005 (EP) EP 05002506.3

(51) Int. Cl. H04B 1/69

(52) U.S. Cl. 375/130

(57) ABSTRACT

An apparatus for serial transmission of data over a transmission path in a vehicle uses spread-spectrum modulation to enhance the electromagnetic compatibility with other electrical and electronic components in the vehicle. The apparatus includes a transmitter that subjects a clock signal having a predetermined frequency and phase to spread-spectrum modulation by wobbling a first clock signal within a predetermined frequency range. The serial data signal is transmitted synchronously with the wobbled first clock signal. The apparatus includes a receiver that uses a blind-oversampling clock and data retrieving unit (CDR unit) to receive the serial data signal. The receiver also generates multiple second clock signals. The CDR unit uses a predetermined algorithm to output the best-suited one of several oversampled serial data signals synchronously with a selected one of the second clock signals. A corresponding method is disclosed for serial transmission of data using spread-spectrum modulation to enhance electromagnetic compatibility.

### CROSS REFERENCE TO RELATED APPLICATION

This application is based on and hereby claims the benefit under 35 U.S.C. §119 from German Application No. 20 2005 001 929.1, filed on Feb. 7, 2005, in Germany, the contents of which are incorporated herein by reference. This application is also based on and claims the benefit under 35 U.S.C. §119 from European Application No. EP 05002506.3, filed on Feb. 7, 2005, in the European Patent Office, the contents of which are incorporated herein by reference. This application is a continuation of German Application No. 20 2005 001 929.1. This application is also a continuation of European Application No. EP 05002506.3.

### TECHNICAL FIELD

The present invention relates generally to the serial transmission of data, and more specifically to using spread-spectrum modulation to enhance the electromagnetic compatibility of a transmission path in an automotive vehicle.

### BACKGROUND

Present methods for transmitting data throughout an automotive vehicle typically rely on low latency transmission that is performed on non-compressed data. FIG. 1 (prior art) shows the basic structure of a transmission apparatus 10 of the prior art. The transmission apparatus includes a transmitter 11 and a receiver 12. Transmitter 11 includes a first phase-locked loop (PLL) 13 and a serializer 14, while receiver 12 includes a second phase-locked loop 15 and a deserializer 16.

First PLL 13 generates from a first basic clock signal T_{REF1} a first clock signal T_{NOM1} that is a multiple of the frequency of first basic clock signal T_{REF1} and has the same phase as first basic clock signal T_{REF1}. Serializer 14 receives first clock signal T_{NOM1} from first PLL 13. In addition, serializer 14 receives parallel line-encoded data 17 and converts the data into a serial data signal 18. Serial data signal 18 is transmitted to receiver 12 synchronously with first clock signal T_{NOM1}.

Second phase-locked loop 15 generates from a second basic clock signal T_{REF2} a second clock signal T_{NOM2}. Second clock signal T_{NOM2} is a multiple of the frequency of second basic clock signal T_{REF2} and has the same phase as does second basic clock signal T_{REF2}. Deserializer 16 of receiver 12 receives second clock signal T_{NOM2}. Deserializer 16 also receives serial data signal 18 from serializer 14. Deserializer 16 converts serial data signal 18 into parallel line-encoded data 19 that is output from receiver 12.

FIG. 2 (prior art) shows the layout of first PLL 13 and of second PLL 15 of the prior art transmission apparatus. Each of first PLL 13 and second PLL 15 includes a phase comparator 20, a voltage-controlled oscillator (VCO) 21 and a 1/N-divider 22. On one input, phase comparator 20 of first PLL 13 receives first basic clock signal T_{REF1}. Phase comparator 20 of second PLL 15 receives second basic clock signal T_{REF2} on one input. The output signal of phase comparator 20 is received by VCO 21. VCO 21 of PLL 13 outputs first clock signal T_{NOM1}, which is both output from PLL 13 and fed back through 1/N divider 22 to phase comparator 20. VCO 21 of PLL 15 outputs second clock signal T_{NOM2}, which is both output from PLL 15 and fed back through 1/N divider 22 to phase comparator 20.

In this way, PLL 13 and PLL 15 output first and second clock signals T_{NOM1} and T_{NOM2}, respectively. First and second clock signals T_{NOM1} and T_{NOM2} have the same phase as do first and second basic clock signals T_{REF1} and T_{REF2}, respectively, which are 1/N times the frequency of first and second clock signals T_{NOM1} and T_{NOM2}, respectively. First clock signal T_{NOM1} is then used for transmitting serial data signal 18, which is generated from parallel line-encoded data 17 synchronously with first basic clock signal T_{REF1} by the serializer 14. Serial data signal 18 is then received by deserializer 16, sampled synchronously with second basic clock signal T_{REF2} and converted into parallel line-encoded data 19. Parallel line-encoded data 19 is then output from receiver 12 for further processing.

Transmission apparatus 10, however, has two inherent drawbacks. The first drawback is the need to use first and second basic clock signals T_{REF1} and T_{REF2} that have the same frequency and phase and that are therefore synchronous with each other. Consequently, it is necessary either to transmit clock information across the transmission path or to derive clock information at receiver 12 from serial data signal 18. Thus, it has heretofore been considered necessary for serial transmission to keep the clock as stable as possible and without any jitter.

The second drawback of transmission apparatus 10 results from the fact that it is difficult to screen data transmission lines in an automotive vehicle completely from environmental radiation. Transmission apparatus 10 uses frequencies in a range of up to 1 GHz. Electromagnetic waves emitted by other electric or electronic components in the automotive vehicle may be coupled into the data transmission lines in the form of electromagnetic interference and thereby reduce the electromagnetic compatibility (EMC). Thus, the locations of transmitter 11 and receiver 12 must be carefully considered when placing data transmission lines.

A transmission apparatus for transmitting data in an automotive vehicle is sought that does not require clock information to be transmitted across the transmission path or to be derived from serial data at the receiver. Moreover, a data transmission apparatus for an automotive vehicle is sought that enables the data transmission lines to be less susceptible to electromagnetic interference.

### SUMMARY

A transmission apparatus uses a spread spectrum in the serial transmission of data to enhance electromagnetic compatibility (EMC). The transmission apparatus includes a transmitter that subjects a clock signal to spread-spectrum modulation by wobbling within a predetermined frequency range. The clock signal has a predetermined frequency and a predetermined phase. The transmitter generates a wobbled clock signal and transmits a serial data signal synchronously with the wobbled clock signal. The transmission apparatus also includes a receiver that receives the serial data signal using a blind-oversampling clock and data retrieving unit (CDR unit). The receiver outputs a retrieved clock signal and retrieved data.

The receiver retrieves the data by sampling the serial data signal with several second clock signals such that several blind-oversampled serial data signals are obtained. A best-suited one of the several blind-oversampled serial data signals that is synchronous with a selected one of the second clock signals is generated using a predetermined algorithm. The phases of the second clock signals differ from one another, but the second clock signals have the same predetermined frequency. The predetermined phase of the first clock signal does not have a predetermined relationship with the mutually different phases of the second clock signals. Moreover, the transmission apparatus does not derive a relationship between the predetermined phase of the first clock signal and the mutually different phases of the second clock signals by using the transmitted serial data signal or the several oversampled clock signals.

The transmitter includes a first phase-locked loop that receives a first basic clock signal and that adjusts the phase of the first clock signal to the phase of the first basic clock signal. The first phase-locked loop also determines the frequency of the first clock signal from the frequency of the first basic clock signal.

The transmitter also includes a serializer that receives parallel line-encoded data and a wobbled first clock signal. The serializer converts the parallel line-encoded data into a serial data signal and transmits the serial data signal synchronously with the wobbled first clock signal.

The first phase-locked loop includes a first phase comparator, a first voltage-controlled oscillator, and a first divider. Both the first phase comparator and the first divider have two input leads. One input lead of the first phase comparator is coupled to the input lead of the first phase-locked loop and receives the first basic clock signal. The input lead of the first voltage-controlled oscillator is coupled to the output lead of the first phase comparator. The first voltage-controlled oscillator receives the output of the first phase comparator and generates an output signal that is output from the first phase-locked loop. The output signal is a wobbled first clock signal.

The first divider is connected in a feedback path between the output lead of the first voltage-controlled oscillator and the second input lead of the first phase comparator. The output signal of the first voltage-controlled oscillator is received on a first input lead of the first divider and is then fed to the second input lead of the first phase comparator such that the first phase comparator performs a comparison between the phase of the first basic clock signal and the phase of the output signal of the first voltage-controlled oscillator that is divided in its frequency by a divider factor of the first divider. A wobbling signal for generating the wobbled first clock signal is received on the second input lead of the first divider. The output of the first phase comparator indicates to the first voltage-controlled oscillator a comparison of the phases of the first basic clock signal and the output signal of the first voltage-controlled oscillator.

The receiver includes a second phase-locked loop, a deserializer, and a blind-oversampling clock and data retrieving unit. The second phase-locked loop receives a second basic clock signal. The second basic clock signal is used to control the phases of the second clock signals output by the second phase-locked loop based on the phase of the second basic clock signal. In addition, the second basic clock signal is used to determine the frequency of the second clock signals based on the frequency of the second basic clock signal.

The blind-oversampling clock and data retrieving unit includes a plurality of shift registers and a multiplexer. The plurality of shift registers detect and store the serial data signal transmitted by the transmitter. The serial data signal is detected using a selected one of the second clock signals. The multiplexer uses a predetermined algorithm to output the best-suited one of the several oversampled serial data signals synchronously with a selected one of the second clock signals.

The deserializer receives the best-suited serial data signal output by the multiplexer and converts the serial data signal into parallel line-encoded data. The parallel line-encoded data is then output from the receiver.

The second phase-locked loop includes a second phase comparator, a second voltage-controlled oscillator, and a second divider. Both the second phase comparator and the second divider have two input leads. The input lead of the second phase-locked loop is coupled to one input lead of the second phase comparator. The second basic clock signal is received onto the input lead of the second phase-locked loop. The output lead of the second phase comparator is coupled to the input lead of the second voltage-controlled oscillator. The second phase comparator compares the phase of the second basic clock signal to several phases.

The second voltage-controlled oscillator receives an output signal from the second phase comparator and generates multiple output signals for the several phases. The output signals are output onto the output leads of the second phase-locked loop. The second divider is connected in a feedback path between the output lead of the second voltage-controlled oscillator and the second input lead of the second phase comparator. The output signals of the second voltage-controlled oscillator are fed through the second divider back to the second input lead of the second phase-locked loop such that the second phase comparator performs a comparison between the phase of the second basic clock signal and the phases of the output signals whose frequency is divided by a divider factor of the second divider. The comparison is performed for the several phases.

The output of the second phase comparator indicates to the second voltage-controlled oscillator a comparison of the phases of the second basic clock signal and the output signals of the second voltage-controlled oscillator.

In accordance with a second aspect of the present invention, a method for serial transmission of data enhances electromagnetic compatibility by using a spread spectrum. The method includes the steps of subjecting a first clock signal having a predetermined frequency and a predetermined phase to spread-spectrum modulation. The first clock signal is wobbled within a predetermined frequency range. A serial data signal is transmitted synchronously with the wobbled first clock signal. The transmitted serial data signal is received using a blind-oversampling clock and data retrieving unit. A receiver outputs retrieved data and at least one of the retrieved clock signals.

Clock and data retrieval is performed such that several blind-oversampled serial data signals are obtained after the transmitted serial data signal is sampled with several second clock signals. A best-suited one of the several blind-oversampled serial data signals is output synchronously with a selected one of the second clock signals using a predetermined algorithm. The phases of the second clock signals differ from one another, but the second clock signals have the same predetermined frequency.

The predetermined phase of the first clock signal does not have a predetermined relationship with the mutually different phases of the second clock signals. Moreover, no relationship between the predetermined phase of the first clock signal and the mutually different phases of the second clock signals is derived by using the transmitted serial data signal or the several oversampled clock signals.

The method also includes the steps of receiving a first basic clock signal, adjusting the phase of the first clock signal to the phase of the first basic clock signal, and determining the frequency of the first clock signal using the frequency of the first basic clock signal. Parallel line-encoded data and the wobbled first clock signal are received, and the parallel line-encoded data is converted to the serial data signal. The serial data signal is transmitted synchronously with the wobbled first clock signal.

By using spread-spectrum modulation to generate a wobbled first clock signal, and by transmitting the serial data signal synchronously with this wobbled first clock signal, a peak in the frequency spectrum of the wobbled serial data signal is substantially reduced so that electromagnetic interference due to a large peak in the frequency spectrum is reduced. Consequently, the electromagnetic compatibility with other electrical and electronic components in an automotive vehicle is increased.

In addition, it is no longer necessary separately to supply clock information from the transmitter to the receiver in order to sample and detect the data signal because clock information and data is retrieved from the transmitted serial data signal itself.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 (prior art) is a schematic block diagram of a transmission apparatus for serial data in the prior art.

FIG. 2 (prior art) is a schematic block diagram of a phase-locked loop used in the transmission apparatus of FIG. 1.

FIG. 3 is a schematic diagram of a transmission apparatus that includes a blind-oversampling clock and data retrieving unit in accordance with the present invention.

FIG. 4 is a schematic diagram of a phase-locked loop used in a transmitter of the transmission apparatus of FIG. 3.

FIG. 5 is a schematic diagram of a phase-locked loop used in a receiver of the transmission apparatus of FIG. 3.

FIG. 6 is a schematic representation of the frequency range as used by the transmission apparatus of FIG. 3.

FIG. 7A is a schematic representation of an example of a serial data signal transmitted from the transmitter of the transmission apparatus of FIG. 3.

FIG. 7B is a schematic representation of an example of first clock signal generated within the transmitter of the transmission apparatus of FIG. 3.

FIG. 8 is a schematic representation of a frequency range of the serial data signal of FIG. 7A transmitted by the transmission apparatus of FIG. 3 without using spread-spectrum modulation.

FIG. 9 is a schematic representation of a frequency range of the serial data signal of FIG. 7A transmitted by the transmission apparatus of FIG. 3 using spread-spectrum modulation.

FIG. 10A is a schematic representation of another example of a serial data signal transmitted from the transmitter of the transmission apparatus of FIG. 3 using scrambling.

FIG. 10B is a schematic representation of an example of first clock signal generated within the transmitter of the transmission apparatus of FIG. 3 as the serial data signal of FIG. 10A is transmitted.

FIG. 11 is a schematic representation of a frequency range of the scrambled serial data signal of FIG. 10A transmitted by the transmission apparatus of FIG. 3 without using spread-spectrum modulation.

FIG. 12 is a schematic representation of a frequency range of the scrambled serial data signal of FIG. 10A transmitted by the transmission apparatus of FIG. 3 using spread-spectrum modulation.

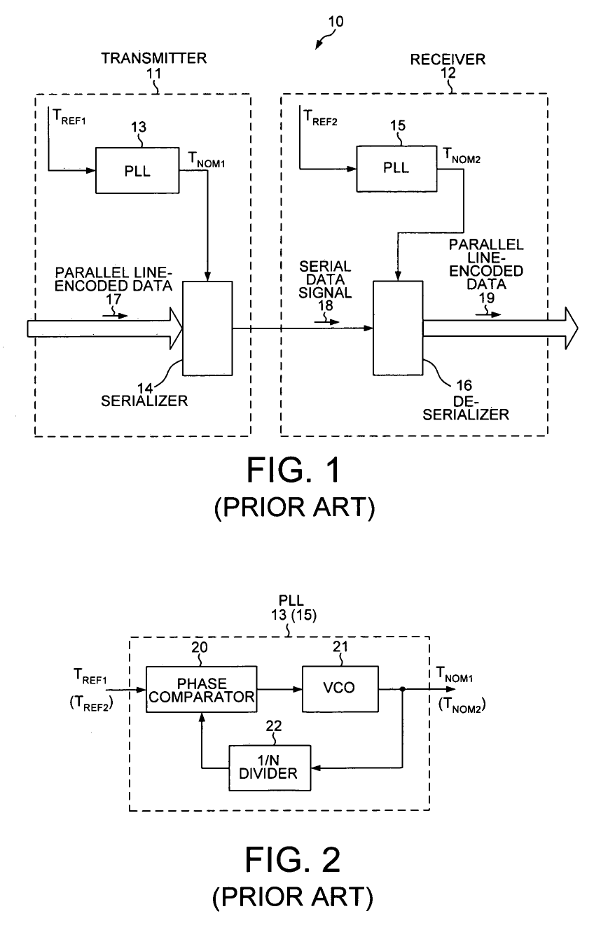

### DETAILED DESCRIPTION

Reference will now be made in detail to some embodiments of the invention, examples of which are illustrated in the accompanying drawings.

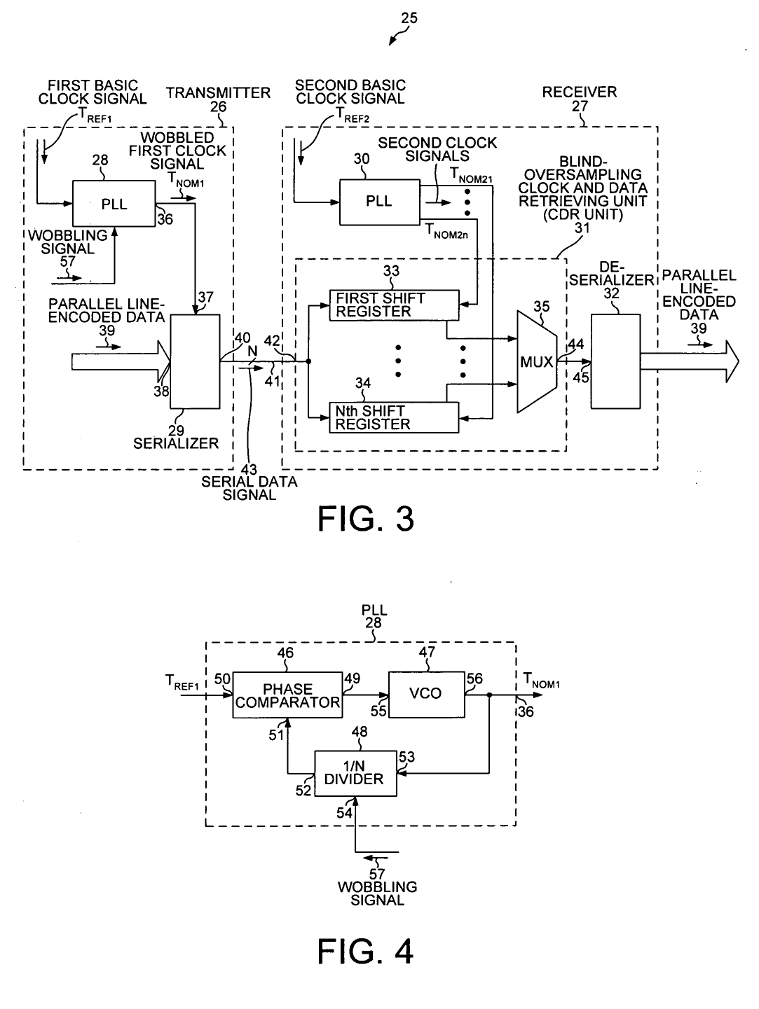

FIG. 3 shows a transmission apparatus 25 for serial data in accordance with one embodiment of the present invention. Transmission apparatus 25 includes a transmitter 26 and a receiver 27. Transmission apparatus 25 is used to provide a reliable serial, digital data path. Other examples of purely serial data transmission, wherein the data path is suited for high scaling, are described in the following three international applications, each of which was filed on Sep. 22, 2003, and published on Mar. 31, 2005: application PCT/EP03/010522 published as WO2005/029869; application PCT/EP03/010523 published as WO2005/029857; and application PCT/EP03/010524 published as WO2005/029740. International applications PCT/EP03/010522, PCT/EP03/010523 and PCT/EP03/010524 are herein incorporated by reference.

In one embodiment, each of transmitter 26 and receiver 27 is an integrated circuit manufactured under the name Gigastar® by Inova Semiconductors GmbH of Munich, Germany. Non-compressed picture element data can be transmitted from transmitter 26 to receiver 27 via a serial high-speed connection using “Shielded Twisted Pair” (STP) cabling. In this embodiment, transmission apparatus 25 provides an outgoing channel for the transmission of the picture element data and control data, as well as a return channel for the transmission of control data. A bidirectional asymmetrical connection is formed via one pair or two pairs of STP cabling. The connection supports data transmissions over a distance of up to 35 meters.

Transmitter 26 includes a first phase-locked loop (PLL) 28 and a serializer 29. Receiver 27 includes a second phase-locked loop (PLL) 30, a blind-oversampling clock and data retrieving unit (CDR unit) 31, and a deserializer 32. CDR unit 31 includes a first shift register 33, an nth shift register 34, and a multiplexer (MUX) 35. Although not shown in FIG. 3, CDR unit 31 also includes registers from the second register through the n-1 register.

First PLL 28 receives a first basic clock signal T_{REF1} having a predetermined frequency and a predetermined phase. An output lead 36 of first PLL 28 is connected to a clock input lead 37 of serializer 29. A data input lead 38 of serializer 29 receives parallel line-encoded data 39. An N-bit output lead 40 of serializer 29 is connected via a transmission path 41 to an input lead 42 of CDR unit 31. More specifically, each of the N registers 33 through 34 is connected to a single-bit output lead of serializer 29. A serial data signal 43 travels along transmission path 41 between transmitter 26 and receiver 27.

Second PLL 30 receives a second basic clock signal T_{REF2} having a predetermined frequency and a predetermined phase. Second PLL 30 has N output leads onto which N clock signals are output, from a first clock signal T_{NOM1} to an Nth clock signal T_{NOM2n}, Respective ones of the N output leads of second PLL 30 are connected to respective ones of clock input leads of the N shift registers, from first shift register 33 through the Nth shift register 34. The output leads of the N shift registers are connected to N data input leads of multiplexer 35. An output lead 44 of multiplexer 35 is coupled to an input lead 45 of deserializer 32.

FIG. 4 shows first PLL 28 of transmitter 26 in more detail. PLL 28 includes a first phase comparator 46, a first voltage-controlled oscillator 47, and a first 1/N divider 48. Phase comparator 46 has an output lead 49, as well as a first input lead 50 and a second input lead 51. Moreover, first 1/N divider 48 has an output lead 52, as well as a first input lead 53 and a programming input lead 54. Output lead 49 of first phase comparator 46 is connected to an input lead 55 of first voltage-controlled oscillator 47. An output lead 56 of first voltage-controlled oscillator 47 is connected to output lead 36 of first PLL 28, as well as to first input lead 53 of first 1/N divider 48. Output lead 52 of first 1/N divider 48 is connected to second input lead 51 of first phase comparator 46. In this way, a feedback path is formed in first PLL 28. First phase comparator 46 receives first basic clock signal T_{REF1} onto first input lead 50. In addition, first 1/N divider 48 receives a wobbling signal 57 on programming input lead 54.

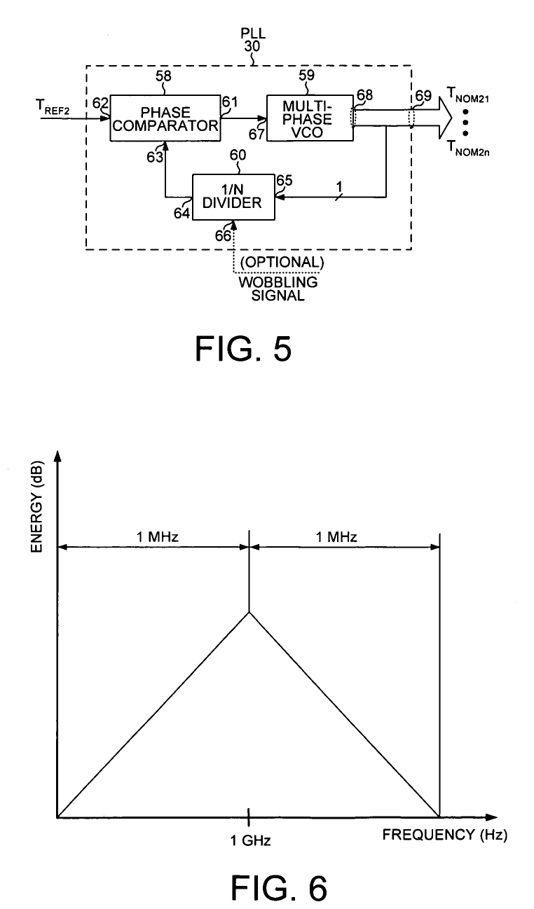

FIG. 5 shows second PLL 30 of receiver 27 in more detail. PLL 30 includes a second phase comparator 58, a second voltage-controlled oscillator for several phases (multi-phase VCO) 59, and a second 1/N divider 60. Phase comparator 58 has an output lead 61, as well as a first input lead 62 and a second input lead 63. Moreover, second 1/N divider 60 has an output lead 64 and a first input lead 65. Optionally, second 1/N divider 60 can have a programming input lead 66. Output lead 61 of second phase comparator 58 is connected to an input lead 67 of multi-phase VCO 59. N output leads 68 of multi-phase VCO 59 are connected to N output leads 69 of second PLL 30. In addition, one of the N output leads 68 is connected to input lead 65 of second 1/N divider 60. Output lead 64 of second 1/N divider 60 is connected to second input lead 63 of second phase comparator 58. In this way, a feedback path is formed in second PLL 30. Second phase comparator 58 receives second basic clock signal T_{REF2} onto first input lead 62.

The operation of transmission apparatus 25 is now described as transmitter 26 transmits serial data signal 43 to receiver 27. First PLL 28 receives first basic clock signal T_{REF1}, which is generated externally to first PLL 28. More specifically, first phase comparator 46 receives first basic clock signal T_{REF1} onto first input lead 50. In addition, first phase comparator 46 receives onto second input lead 51 a signal that is fed back via first 1/N divider 48 from output lead 56 of first voltage-controlled oscillator 47. The signal that is fed back has a frequency equal to 1/N times that of first basic clock signal T_{REF1}. As a result of this feedback, a first clock signal T_{NOM1} is output onto output lead 36 of first PLL 28 that has a frequency that is derived from the frequency of first basic clock signal T_{REF1} and that has a phase that is identical to the phase of first basic clock signal T_{REF1}. The frequency of first clock signal T_{NOM1} is equal to N times the frequency of first basic clock signal T_{REF1}. In this embodiment, N is an arbitrary real number greater than zero that is determined based on the application in which transmission apparatus 25 is used. In addition, first 1/N divider 48 receives a wobbling signal 57 on programming input lead 54. Wobbling signal 57 is used to program a divider ratio of first 1/N divider 48.

FIG. 6 is a schematic representation of the frequency range used by transmission apparatus 25. FIG. 6 shows the range in which first clock signal T_{NOM1} wobbles. First clock signal T_{NOM1} has a frequency of f_{NOM1}=1 GHz and is altered at a small sweep width of f_{NOM1}=±1 MHz with a fast speed change of the sweep width of f_{FM1}=2.6 kHz. The wobbling is achieved by supplying a suitable wobbling signal 57 to programming input lead 54 of first 1/N divider 48. Although wobbling in this embodiment is carried out as rapidly as possible and over a small sweep width with the values indicated above, other values for wobbling are suitable depending on the application in which transmission apparatus 25 is used. Wobbling first clock signal T_{NOM1} subjects serial data signal 43 to spread-spectrum modulation.

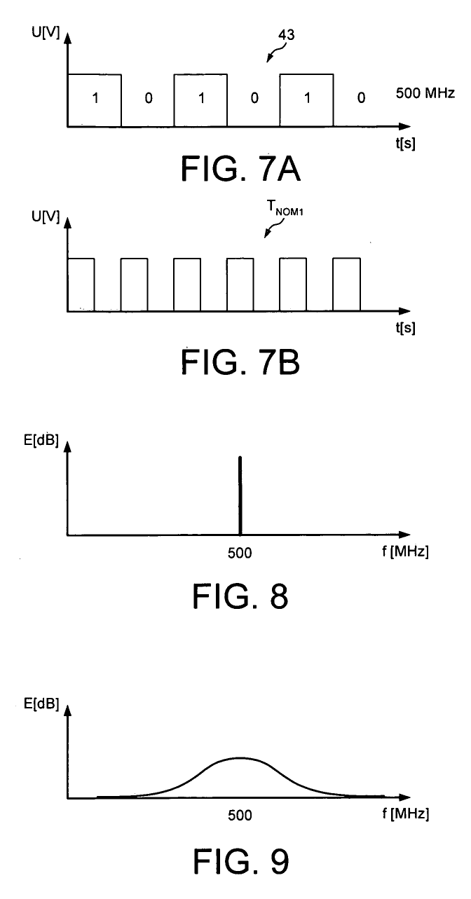

FIG. 7A is a schematic representation of one example of serial data signal 43 that is transmitted by transmitter 26. FIG. 7A shows amplitude U[V] versus time t[s]. In this first example of the operation of transmission apparatus 25 without spread-spectrum modulation, serial data signal 43 is assumed to consist of a constantly alternating sequence of is and zeros, as shown in FIG. 7A. This serial data signal 43 travels along transmission path 41 between transmitter 26 and receiver 27 without the influence of wobbling signal 57. FIG. 7B shows one example of first clock signal T_{NOM1} at 1 GHz without the influence of wobbling signal 57. In this example, after parallel line-encoded data 39 is input into serializer 29, serial data signal 43 with a frequency of 500 MHz is transmitted synchronously with the 1 GHz frequency of first clock signal T_{NOM1} across transmission path 41 from transmitter 26 to CDR unit 31 of receiver 27.

FIG. 8 is a graph of amplitude E(dB) versus frequency for the serial data signal 43 of FIG. 7A. The frequency range of the amplitude of serial data signal 43 shown in FIG. 8 is obtained without using wobbling signal 57 and therefore without spread-spectrum modulation. The transmission of the constantly alternating sequence of 1 s and zeros on transmission path 41 between transmitter 26 and receiver 27 results in an extreme case in which a large peak of amplitude exists at 500 MHz and no other frequency components exist.

Transmission path 41 between transmitter 26 and receiver 27 in an automotive vehicle is typically exposed to electromagnetic interference from both other electric and electronic components within the vehicle and from electromagnetic interferences outside the automotive vehicle, because transmission path 41 is typically STP cabling that cannot be entirely electromagnetically shielded. As a result of the high frequency of the 500-MHz serial data signal 43 in FIG. 7A, there is a high likelihood that electromagnetic interference will be coupled into transmission path 41 and will impair, or interfere with, serial data signal 43. This interference can be avoided by using wobbling signal 57 and subjecting serial data signal 43 to spread-spectrum modulation.

FIG. 9 is a graph of amplitude versus frequency for serial data signal 43 when wobbling signal 57 is used to perform spread-spectrum modulation on serial data signal 43. As a result of the wobbling performed at first 1/N divider 48, the spectrum of serial data signal 43 that is transmitted on transmission path 41 between transmitter 26 and receiver 27 is altered such that the spike of amplitude at 500 MHz shown in FIG. 8 is now “spread”, as is shown in FIG. 9. Note that the amplitudes shown in FIGS. 8 and 9 are not drawn to linear scale with regard to amplitude U[V]. Rather, the spread-spectrum modulation achieved by wobbling reduces the amplitude of the spike by powers of ten. The energy of the spike is distributed over a larger frequency range as shown in FIG. 9. The electromagnetic compatibility of transmission path 41 between transmitter 26 and receiver 27 is enhanced by using spread-spectrum modulation to reduce and spread out the amplitude of the spike in the frequency range of serial data signal 43.

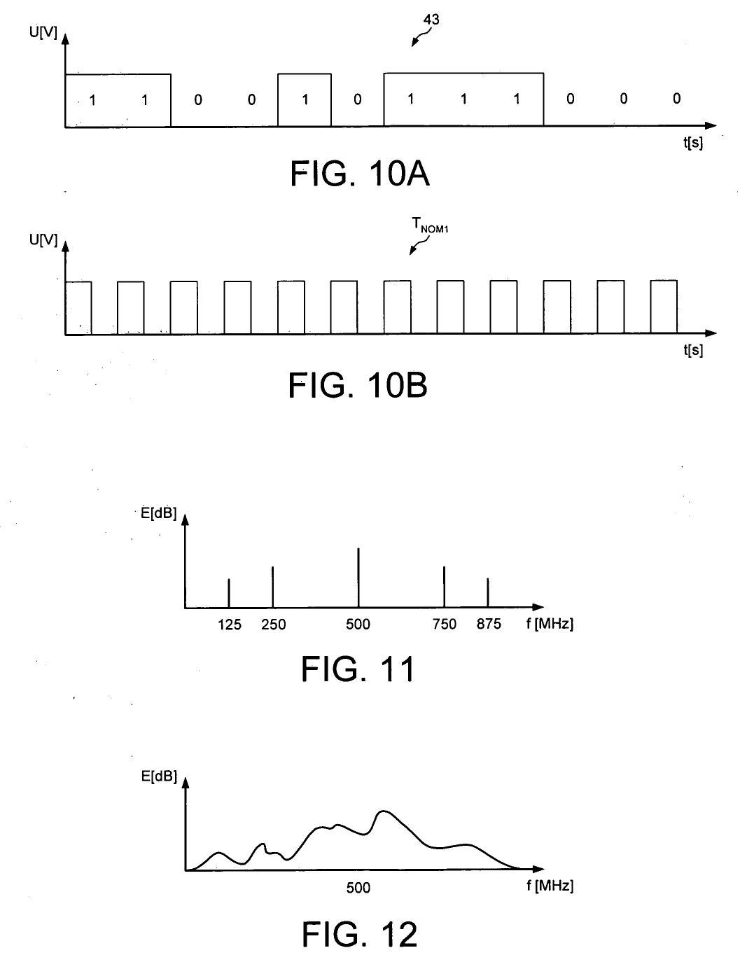

FIG. 10A is a schematic representations of another example of serial data signal 43 that is transmitted by transmitter 26. This example of the operation of transmission apparatus 25 uses scrambling as well as spread-spectrum modulation. In addition to the above-mentioned spread-spectrum modulation, serial data signal 43 is subjected to scrambling in order further to reduce the peak amplitude in the frequency range. In this example, the constantly alternating sequence of 1 s and zeros shown in FIG. 7A is scrambled to obtain the sequence of 1 s and zeros as shown in FIG. 10A. FIG. 10B shows first clock signal T_{NOM1} with a frequency of 1 GHz. Conventional scrambling methods can be used. When more intense scrambling methods are used, however, a greater bandwidth and consequently a higher frequency becomes necessary for serial data signal 43.

FIG. 11 is a graph of amplitude E(dB) versus frequency for the serial data signal 43 of FIG. 10A. Scrambling the serial data signal 43 of FIG. 7A converts that constant sequence of is and zeros into another sequence that does not have only a single peak at the frequency of 500 MHz, but rather the multiple peaks of FIG. 11. The multiple peaks of the frequency spectrum obtained by scrambling are arranged by positive and negative integer parts on either side of the spike at 500 MHz of the unscrambled serial data signal 43. The frequency spectrum of amplitude of serial data signal 43 shown in FIG. 11 is obtained without using wobbling signal 57 and therefore without spread-spectrum modulation.

FIG. 12 is a graph of amplitude versus frequency for serial data signal 43 when wobbling signal 57 is used to perform spread-spectrum modulation on serial data signal 43 of FIG. 10A. By using wobbling to achieve spread-spectrum modulation, the frequency spectrum of FIG. 11 with multiple peaks is now “spread” in a similar fashion to the frequency spectrum of FIG. 9 and similar advantages are obtained. Due to the several peaks in the frequency spectrum of the scrambled serial data signal 43 of FIG. 11, the “spread” serial data signal obtained using wobbling is present over a larger frequency range than the unscrambled, “spread” serial data signal shown in FIG. 9. It should be noted, however, that scrambling serial data signal 43 is optional and may or may not be used depending on the application in which transmission apparatus 25 is used. For each application, the advantages of scrambling, i.e., avoiding a single peak at a high frequency, must be weighed against the drawbacks of scrambling, i.e., overhead, larger bandwidth, and increased frequency.

Returning to FIG. 3, the unscrambled or scrambled serial data signal 43 obtained in the manner described above is transmitted synchronously with first clock signal T_{NOM1} over transmission path 41 between transmitter 26 and receiver 27 to CDR unit 31. More specifically, serial data signal 43 is received on each of the N registers from first shift register 33 through the Nth shift register 34.

On receiver 27, second PLL 28 receives second basic clock signal T_{REF2}. Second basic clock signal T_{REF2} has the same frequency as first basic clock signal T_{REF1} but not necessarily the same phase. The phases of first basic clock signal T_{REF1} and second basic clock signal T_{REF2}, however, having a predetermined relationship. Second phase comparator 58 receives second basic clock signal T_{REF2} on first input lead 62. On second input lead 63, second phase comparator 58 receives a signal that is fed back via second 1/N divider 60 from output lead 68 of multi-phase VCO 59. This feedback signal has a frequency equal to 1/N times that of second basic clock signal T_{REF2}. The feedback signal causes PLL 30 to output second clock signals T_{NOM21} through T_{NOM2n}, each having a frequency derived from the frequency of second basic clock signal T_{REF2}, and each having a phase identical to the phase of second basic clock signal T_{REF2}. The frequency of second clock signals T_{NOM21} to T_{NOM2n} is equal to N times the frequency of second basic clock signal T_{REF2}. N is an arbitrary real number greater than zero that is determined based on the application in which transmission apparatus 25 is used. N need not correspond, however, to the value of N of first 1/N divider 48.

In one example of second clock signals T_{NOM21} through T_{NOM2n}, eight second clock signals T_{NOM21} to T_{NOM28} are output from second PLL 30 and are received on respective inputs of first shift register 33 through eighth shift registers 34. In order to ensure sufficient blind oversampling in this example, the frequency of the first through eighth second clock signals T_{NOM21} to T_{NOM28} is equal to the frequency of first clock signal T_{NOM1}, i.e., 1 GHz. By using the same divider ratio N as that of second 1/N divider 48, second clock signals T_{NOM21} to T_{NOM2n} have the same frequency but mutually different phases, for example, phases that differ by 45 degrees. Second clock signals T_{NOM21} to T_{NOM28} are received on the clock input leads of first shift register 33 through eighth shift registers 34. At each clock pulse of first to eighth second clock signals T_{NOM21} to T_{NOM28}, transmitted serial data signal 43 is sampled with the transmitted serial clock signal and is written into one of the N registers from first shift register 33 through the Nth shift register 34. The N registers may, for instance, each be a 10-bit ring oscillator that stores ten bits that are sampled at ten sampling times of each of the first through eighth second clock signals T_{NOM21} to T_{NOM28}. From among the eight bits of the transmitted serial data signal 43 that correspond to each other but that were sampled by the first through eighth second clock signals T_{NOM21} to T_{NOM28} at different sampling times, the one bit satisfying predetermined conditions is selected. The multiplexer uses a predetermined algorithm to output the best-suited one of the several oversampled serial data signals synchronously with a selected one of the second clock signals.

Blind oversampling may, for example, be performed such that serial data signal 43, which was generated synchronously with first clock signal T_{NOM1}, is sampled by one of second clock signals T_{NOM21} to T_{NOM28}. Second clock signals T_{NOM21} to T_{NOM28} are chosen such that they permit multiple sampling during a single period of serial data signal 43, i.e., oversampling is performed. To accomplish the oversampling, the frequency of second clock signals T_{NOM21} to T_{NOM28} may be selected to be identical to the frequency of first clock signal T_{NOM1}, in which case second clock signals T_{NOM21} to T_{NOM28} are shifted relative to one another by a common phase increment.

In another embodiment, the frequency of a single second clock signal T_{NOM21} to T_{NOM21}, is chosen to be higher by a multiple than the frequency of first clock signal T_{NOM1}.

Although clock and data retrieval is performed using blind oversampling as described above, other methods for clock and data retrieval are possible. Various other methods for clock and data retrieval include: analog, PLL based clock and data retrieval; blind oversampling with or without clock synthesis; blind oversampling with an analog voltage-controlled oscillator; clock and data retrieval with a bang-bang architecture; and clock and data retrieval with a linear phase detector.

The eight bits of the transmitted serial data signal 43 correspond to each other but were sampled at different sampling times by the first through eighth second clock signals T_{NOM21} to T_{NOM28}. The most reliable bit of the eight bits of the transmitted serial data signal 43 is then output by multiplexer 35. Logic not shown in FIG. 3 controls multiplexer 35 such that it selects the input corresponding to the most reliable bit. The most reliable bit is then supplied to deserializer 32 for retrieving the parallel line-encoded data 39. Both multiplexer 35 and deserializer 32 operate synchronously with a specific one of second clock signals T_{NOM2}1 to T_{NOM28}. The line-encoded data 39 thus retrieved is subsequently output from receiver 27 and subjected to further processing.

As disclosed above with respect to FIG. 5, second 1/N divider 60 can optionally also have a programming input lead 66 that receives a wobbling signal to perform wobbling on the side of receiver 27 in the same manner as described with respect to wobbling on the side of transmitter 26. When wobbling is performed both on transmitter 26 and on receiver 27, the wobbling signals on both sides should wobble in the same manner. This has the advantage that either the tolerance of the second phase comparator can be decreased, or the wobbling range can be increased. There are at least two operational modes. In a first mode, the wobbling signal is not used and therefore the dividing ratio of second 1/N divider 60 is fixed. In the second mode, the wobbling signal is used. In that case, the wobbling signal must be generated such that the wobbling signal on the side of receiver 27 performs the same changes at the same time as wobbling signal 57 on the side of transmitter 26. This can be achieved by generating the wobbling signal on the side of receiver 27 from information describing wobbling signal 57 on the side of transmitter 26 that is sent to the side of receiver 27. Alternatively, a wobbling signal on receiver 27 can be generated that is similar to wobbling signal 57 on transmitter 26 by applying a predetermined rule to generate the wobbling signal on receiver 27 without receiving any information about wobbling signal 57. For example, if it is known or can be predicted when wobbling signal 57 on transmitter 26 wobbles and how it wobbles, then a wobbling signal on receiver 27 can be generated based on that information without receiving any additional information from transmitter 26 about the wobbling of wobbling signal 57.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A device comprising:
a transmitter that generates a wobbled first clock signal and that transmits a serial data signal synchronously with the wobbled first clock signal, wherein the transmitter generates the wobbled first clock signal by subjecting a first basic clock signal to spread-spectrum modulation; and
a receiver that receives the serial data signal and that generates several oversampled serial data signals using a blind-oversampling clock and data retrieving unit, wherein the receiver generates a plurality of second clock signals, and wherein the receiver outputs a best-suited one of the several oversampled serial data signals synchronously with a selected one of the plurality of second clock signals.

2. The device of claim 1, wherein the first basic clock signal has a predetermined frequency, and wherein each of the plurality of second clock signals has the same predetermined frequency as the first clock signal, and wherein the plurality of second clock signals have mutually different phases.

3. The device of claim 2, wherein the first basic clock signal has a phase that does not have a predetermined relationship with any of the mutually different phases of the plurality of second clock signals.

4. The device of claim 1, wherein the receiver samples the serial data signal with the plurality of second clock signals to generate the several oversampled serial data signals.

5. The device of claim 1, wherein the best-suited one of the several oversampled serial data signals is determined using a predetermined algorithm.

6. The device of claim 1, wherein the first basic clock signal is wobbled within a predetermined frequency range.

7. The device of claim 1, wherein the transmitter comprises a serializer, wherein the serializer receives parallel line-encoded data and the wobbled first clock signal, and wherein the serializer outputs the serial data signal.

8. The device of claim 1, wherein the transmitter comprises a first phase-locked loop that receives the first basic clock signal and outputs the wobbled first clock signal.

9. The device of claim 1, wherein the first phase-locked loop comprises:
a first phase comparator that receives the first basic clock signal on a first input lead;
a first voltage-controlled oscillator that receives an output signal from the first phase comparator; and
a first divider with a first input lead, a programming input lead and an output lead, wherein the first input lead of the first divider is coupled to an output lead of first voltage-controlled oscillator, wherein the output lead of first divider is coupled to a second input lead of first phase comparator, and wherein a wobbling signal is received on the programming input lead of the first divider.

10. The device of claim 1, wherein the receiver comprises a second phase-locked loop that receives a second basic clock signal, wherein the second phase-locked loop outputs the plurality of second clock signals, and wherein the first basic clock signal and the second basic clock signal have the same frequency.

11. The device of claim 1, wherein the blind-oversampling clock and data retrieving unit comprises a plurality of shift registers and a multiplexer, and wherein the multiplexer outputs the best-suited one of the several oversampled serial data signals.

12. The device of claim 11, wherein the receiver comprises a deserializer that receives the best-suited one of the several oversampled serial data signals from the blind-oversampling clock and data retrieving unit, and wherein the deseriallizer outputs parallel line-encoded data.

13. A method comprising:
generating a wobbled first clock signal by subjecting a first clock signal to spread-spectrum modulation using a wobbling signal;
transmitting a serial data signal synchronously with the wobbled first clock signal;
receiving the serial data signal;
generating a plurality of second clock signals;
generating several oversampled serial data signals using a blind-oversampling clock and data retrieving unit; and
outputting a best-suited one of the several oversampled serial data signals synchronously with a selected one of the plurality of second clock signals.

14. The method of claim 13, wherein the best-suited one of the several oversampled serial data signals is output using a predetermined algorithm.

15. The method of claim 13, wherein the first clock signal has a predetermined frequency, and wherein each of the plurality of second clock signals has the same predetermined frequency as the first clock signal, and wherein the plurality of second clock signals have mutually different phases.

16. The method of claim 15, wherein the first basic clock signal has a phase that does not have a predetermined relationship with any of the mutually different phases of the plurality of second clock signals.

17. The method of claim 13, further comprising:
receiving parallel line-encoded data; and
converting the parallel line-encoded data to the serial data signal.

18. A system comprising:
a transmission path in an automotive vehicle, wherein a serial data signal is transmitted across the transmission path, wherein the serial data signal exhibits a frequency spectrum, and wherein electromagnetic interference is emitted by electronic components in the automotive vehicle; and
means for making the transmission path less susceptible to the electromagnetic interference by spreading the frequency spectrum of the serial data signal.

19. The method of claim 18, wherein the means generates a wobbled clock signal and transmits the serial data signal across the transmission path synchronously with the wobbled clock signal.

20. The method of claim 19, wherein the means generates the wobbled clock signal by subjecting a basic clock signal to spread-spectrum modulation, and wherein the means uses spread-spectrum modulation to spread the frequency spectrum of the serial data signal.
